(19) United States
(12) Patent Application Publication
(10) Pub. No.: US 2021/0175646 A1
(43) Pub. Date: Jun. 10, 2021

(54) JOINT CONNECTOR

(71) Applicants: HYUNDAI MOTOR COMPANY, Seoul (KR); KIA MOTORS CORPORATION, Seoul (KR)

(72) Inventors: Jong Pil Choi, Hwaseong-si (KR); Kwon Il Cho, Hwaseong-si (KR)

(73) Assignees: HYUNDAI MOTOR COMPANY, Seoul (KR); KIA MOTORS CORPORATION, Seoul (KR)

(21) Appl. No.: 16/933,192

(22) Filed: Jul. 20, 2020

(30) Foreign Application Priority Data
Dec. 4, 2019 (KR) 10-2019-0160197

(51) Int. Cl. H01R 9/24; H01R 13/52; H01R 13/05

(52) U.S. Cl. CPC H01R 9/2491; H01R 13/05; H01R 13/5208

(57) ABSTRACT

A joint connector includes: a bus bar having a plurality of male terminals; a plurality of female terminals electrically connected to the plurality of male terminals; a housing having a cavity receiving the bus bar and the plurality of female terminals; and a seal block having a plurality of receiving holes and contacting the housing, wherein each receiving hole receives an electrical wire connected to each female terminal.

### CROSS-REFERENCE TO RELATED APPLICATION

This application is based on and claims the benefit of priority to Korean Patent Application No. 10-2019-0160197, filed on Dec. 4, 2019, in the Korean Intellectual Property Office, the disclosure of which is incorporated herein in its entirety by reference.

### TECHNICAL FIELD

The present disclosure relates to a joint connector, and more particularly, to a joint connector capable of improving sealability between a wire connected to a female terminal and a housing.

### BACKGROUND

In general, an electrical connector is used for the connection of two or more wires to carry electrical energy or to carry electrical signals or information. A pair of connectors may be joined in a male-to-female form. Such a pair of connectors may be combined to form a connector assembly.

A joint connector includes a bus bar having a plurality of male terminals, a plurality of female terminals electrically connected to the male terminals of the bus bar, and a housing receiving the bus bar and the plurality of female terminals. The plurality of female terminals may be electrically connected by the bus bar. For example, the joint connector distributes electrical energy input from one battery to a plurality of electrical components or performs vehicle grounding.

A joint connector according to the related art is provided with a seal member individually mounted on the periphery of each female terminal in order to secure sealability between each female terminal and the housing. Since the seal member is individually mounted on the periphery of each female terminal, the assembly thereof is complex, and the manufacturing cost thereof is increased.

In the joint connector according to the related art, a leaf spring structure is integrally formed in the female terminal. As the leaf spring structure elastically presses the male terminal, an electrical contact between the female terminal and the male terminal may be reliably maintained. However, as the joint connector is frequently checked in a vehicle manufacturing process, the female terminal and the male terminal may be repeatedly disconnected and connected. Thus, the leaf spring structure of the female terminal may be easily deformed, and this may result in high probability of contact failure between the female terminal and the male terminal.

In addition, it is very complex to manufacture, such as by machining, the leaf spring structure in the female terminal. It is not easy to perform inspection and dimensional measurement of the leaf spring structure of the female terminal. This makes it difficult to secure the quality of the leaf spring structure, increases the size of the female terminal, and increases the manufacturing cost.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a joint connector capable of improving the sealability between a wire connected to a female terminal and a housing.

According to an aspect of the present disclosure, a joint connector may include: a bus bar having a plurality of male terminals; a plurality of female terminals electrically connected to the plurality of male terminals; a housing having a cavity receiving the bus bar and the plurality of female terminals; and a seal block having a plurality of receiving holes, and contacting the housing, wherein each receiving hole may receive an electrical wire connected to each female terminal.

The housing may have a first portion and a second portion. The cavity may be defined within the second portion of the housing. The first portion of the housing may have a plurality of terminal passing holes communicating with the cavity and each female terminal may pass through each terminal passing hole.

The plurality of receiving holes may be aligned with the plurality of terminal passing holes.

The joint connector may further include a first cover and a second cover facing the first cover to cover the housing. The first cover may be adjacent to the first portion of the housing, and the seal block may be interposed between the first cover and the first portion of the housing.

The seal block may include a plurality of outer seal lips protruding from an outer surface of the seal block toward the first cover, and a plurality of inner seal lips protruding from an inner surface of the receiving hole toward a center of the receiving hole.

The second cover may have a ledge extending toward the first cover, the seal block may be located within the ledge, the plurality of outer seal lips may contact the ledge, and the plurality of inner seal lips may contact the electrical wires connected to the plurality female terminals.

The first cover may have a plurality of insertion holes aligned with the plurality of terminal passing holes, and each female terminal may be received in the cavity through each insertion hole.

The bus bar may have a strip extending in a width direction of the housing, and the plurality of male terminals may extend from the strip.

Each male terminal may have a leaf spring structure, and the leaf spring structure may be provided at an end portion of the male terminal.

The leaf spring structure may include an upper spring and a lower spring facing the upper spring.

The female terminal may have a terminal cavity receiving the leaf spring structure of the male terminal.

The female terminal may be a clean body terminal.

### BRIEF DESCRIPTION OF THE DRAWINGS

The above and other objects, features and advantages of the present disclosure should be more apparent from the following detailed description taken in conjunction with the accompanying drawings:

FIG. 1 illustrates a perspective view of a joint connector according to an embodiment of the present disclosure;

FIG. 2 illustrates a cross-sectional view, taken along line A-A of FIG. 1;

FIG. 3 illustrates an exploded perspective view of a joint connector according to an embodiment of the present disclosure;

FIG. 4 illustrates an assembly process of a joint connector according to an embodiment of the present disclosure, in which a plurality of bus bars is received in a cavity of a housing;

FIG. 5 illustrates an assembly process of a joint connector according to an embodiment of the present disclosure, in which a terminal position assurance (TPA) mechanism is received in a mounting space of a housing;

FIG. 6 illustrates an assembly process of a joint connector according to an embodiment of the present disclosure, in which a seal block and a first cover are coupled to a housing;

FIG. 7 illustrates a state of a joint connector according to an embodiment of the present disclosure, in which a seal block and a first cover are coupled to a first portion of a housing;

FIG. 8 illustrates a perspective view, which is viewed from a direction indicated by arrow B of FIG. 7;

FIG. 9 illustrates a cross-sectional view, taken along line C-C of FIG. 7;

FIG. 10 illustrates an assembly process of a joint connector according to an embodiment of the present disclosure, in which a female terminal is moving toward a male terminal within a cavity of a housing;

FIG. 11 illustrates a state of a joint connector according to an embodiment of the present disclosure, in which locking lances engage with engaging shoulders of female terminals within a cavity of a housing;

FIG. 12 illustrates a perspective view of a male terminal of a joint connector according to an embodiment of the present disclosure;

FIG. 13 illustrates a perspective view of a female terminal of a joint connector according to an embodiment of the present disclosure;

FIG. 14 illustrates a cross-sectional view of disconnection of a female terminal and a male terminal in a joint connector according to an embodiment of the present disclosure;

FIG. 15 illustrates a cross-sectional view of connection of a female terminal and a male terminal in a joint connector according to an embodiment of the present disclosure;

FIG. 16 illustrates an assembly process of a joint connector according to an embodiment of the present disclosure, in which a second cover is coupled to a first cover; and

FIG. 17 illustrates a state of a joint connector according to an embodiment of the present disclosure, in which a first cover and a second cover are assembled.

### DETAILED DESCRIPTION

Hereinafter, specific embodiments of the present disclosure are described in detail with reference to the accompanying drawings. In the drawings, the same reference numerals are used throughout to designate the same or equivalent elements. In addition, a detailed description of well-known techniques associated with the present disclosure has been omitted in order not to unnecessarily obscure the gist of the present disclosure.

Terms such as first, second, A, B, (a), and (b) may be used to describe the elements in embodiments of the present disclosure. These terms are only used to distinguish one element from another element and the intrinsic features, sequence or order, and the like of the corresponding elements are not limited by the terms. Unless otherwise defined, all terms used herein, including technical or scientific terms, have the same meanings as those generally understood by those having ordinary skill in the art to which the present disclosure belongs. Such terms as those defined in a generally used dictionary are to be interpreted as having meanings equal to the contextual meanings in the relevant field of art. Such terms are not to be interpreted as having ideal or excessively formal meanings unless clearly defined as having such in the present application.

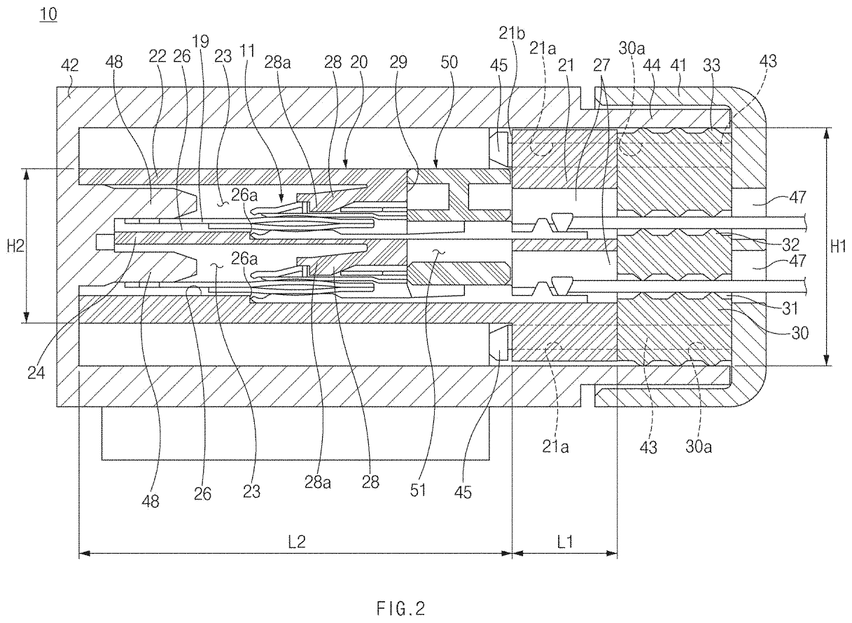

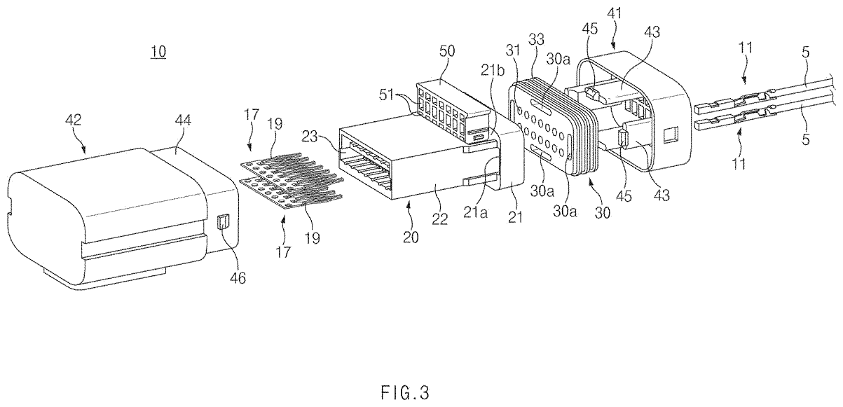

Referring to FIGS. 2 and 3, a joint connector 10 according to an embodiment of the present disclosure may include a housing 20 having a first portion 21 and a second portion 22.

Referring to FIGS. 2-5, the housing 20 may have the first portion 21 and the second portion 22. The first portion 21 may be a cube having a first height H1, a first width W1, and a first length L1. The second portion 22 may be a cube having a second height H2, a second width W2, and a second length L2. The first height H1 of the first portion 21 may be greater than the second height H2 of the second portion 22 and the first width W1 of the first portion 21 may be greater than the second width W2 of the second portion 22. Thus, a transverse cross-sectional area of the first portion 21 may be greater than a transverse cross-sectional area of the second portion 22.

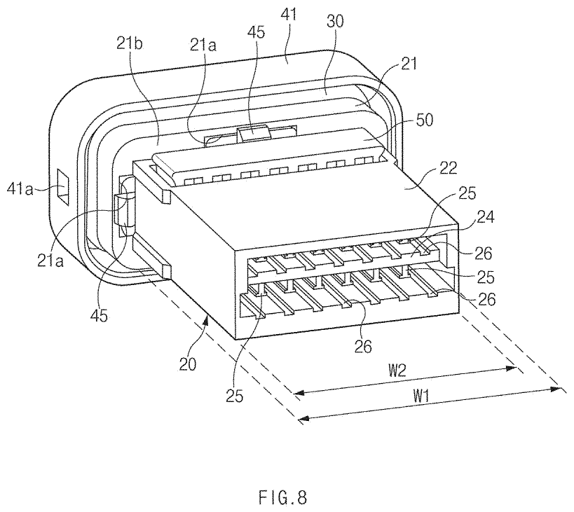

Further referring to FIG. 8, the housing 20 may have a cavity 23 receiving a plurality of female terminals 11 and a bus bar 17 and the bus bar 17 may have a plurality of male terminals 19. The female terminals 11 may be electrically connected to the corresponding male terminals 19 within the cavity 23. A horizontal partition 24 and a plurality of vertical partitions 25 may be provided within the cavity 23 and the horizontal partition 24 and each of the plurality of vertical partitions 25 may partition a space that receives each female terminal 11 and each male terminal 19. The horizontal partition 24 and a bottom of the housing 20 may have a plurality of recesses 26, each of which receives each female terminal 11 and each male terminal 19. Each recess 26 may have a stopper 26a restricting a position of the female terminal 11 and the stopper 26a may be stepped, i.e., extended from an end of the recess 26 downwardly. As a bottom end of the female terminal 11 is caught, i.e., stopped by the stopper 26a, the position of the female terminal 11 may be restricted. The cavity 23 may be defined within the second portion 22, and the second length L2 of the second portion 22 may be greater than the first length L1 of the first portion 21 so that the cavity 23 may have enough space. Thus, there may be enough space for electrical connections between the female terminals 11 and the male terminals 19.

Referring to FIGS. 2 and 9-11, the housing 20 may have a plurality of locking lances 28, and each locking lance 28 may extend obliquely from a top wall of the second portion 22 of the housing 20 and the horizontal partition 24 toward each recess 26. The locking lance 28 may be elastically deformed. The locking lance 28 may have an engaging end 28a releasably engaging with an engaging shoulder 16 of the female terminal 11 and a shape of the engaging end 28a may correspond to that of the engaging shoulder 16.

The first portion 21 of the housing 20 may have a plurality of terminal passing holes 27, through which the plurality of female terminals 11 individually pass. The plurality of terminal passing holes 27 may communicate with the cavity 23. In particular, the terminal passing holes 27 may be aligned with the corresponding recesses 26.

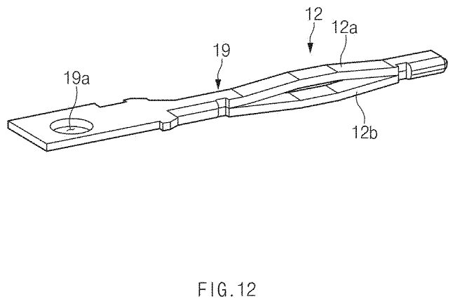

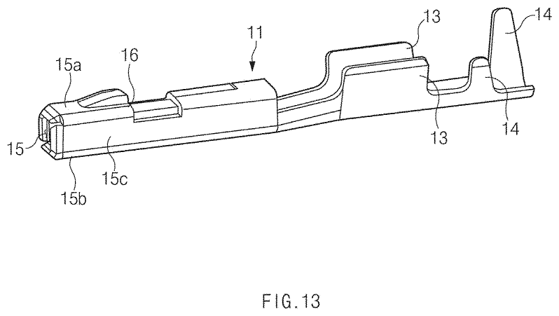

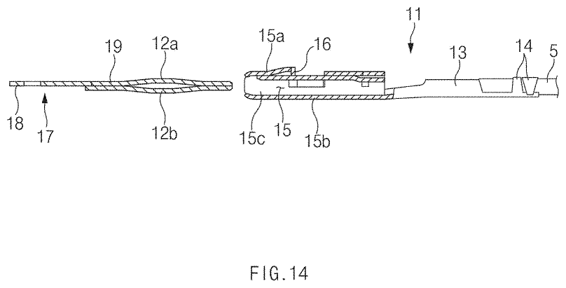

Referring to FIGS. 12-14, each female terminal 11 may be connected to an end of an electrical wire 5 through a conductor gripper 13 and an insulator gripper 14. The conductor gripper 13 may grip a conductor of the electrical wire 5, and the insulator gripper 14 may grip an insulating cover of the electrical wire 5. Each female terminal 11 may have a terminal cavity 15 receiving each male terminal 19. The terminal cavity 15 may be defined by a top wall 15a, a bottom wall 15b, and two sidewalls 15c. The terminal cavity 15 may form a clean body terminal, without a leaf spring structure, and have the smooth surface. When the female terminal 11 passes through a receiving hole 31 of a seal block 30 (further referring to FIG. 3), the receiving hole 31 of the seal block 30 may not be damaged, and the possibility of deformation of the female terminal 11 may be significantly reduced. The top wall 15a of the female terminal 11 may have the engaging shoulder 16, with which the locking lance 28 of the housing 20 releasably engages. Each female terminal 11 may be a clean body terminal.

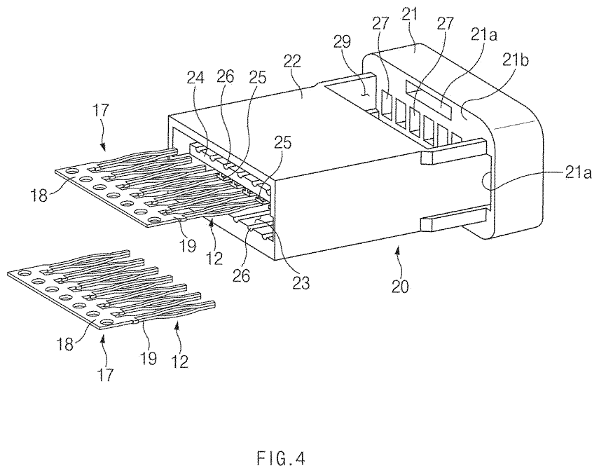

Referring to FIGS. 3 and 4, the bus bar 17 may include a strip 18 and the plurality of male terminals 19 extending from the strip 18. Each male terminal 19 may extend from the strip 18 toward each female terminal 11, and the plurality of male terminals 19 may be electrically connected through the strip 18. The strip 18 may extend in a width direction of the housing 20. The plurality of male terminals 19 may be spaced apart from each other by a predetermined gap along the strip 18. The gap between adjacent male terminals 19 may correspond to a thickness of the vertical partition 25, and the strip 18 of the bus bar 17 may be restricted by the vertical partition 25 within the cavity 23 of the housing 20. The vertical partition 25 may be fitted between the adjacent male terminals 19 of the bus bar 17 so that the bus bar 17 may be press-fitted into the cavity 23 of the housing 20.

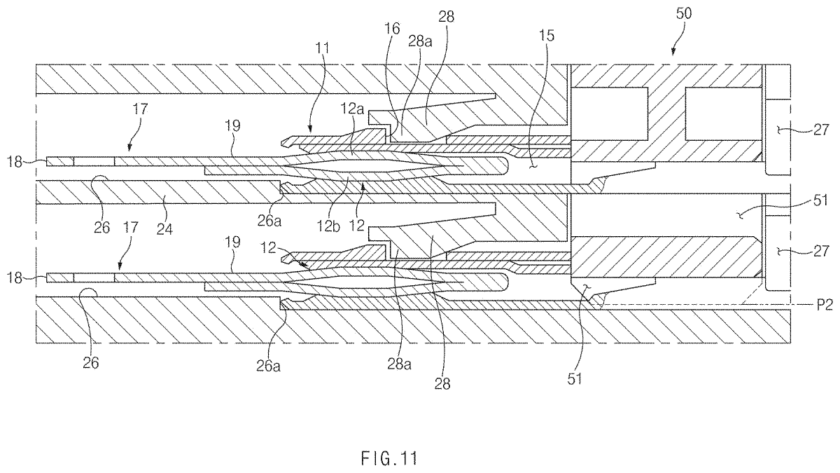

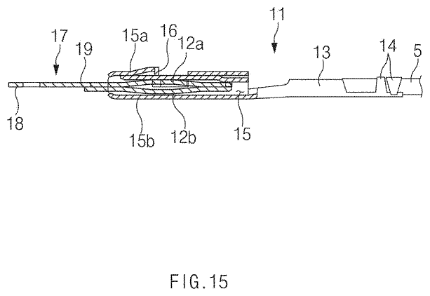

Further referring to FIG. 12, each male terminal 19 may have an engaging hole 19a, to which a fastener is fastened. As the fastener is fastened to the engaging hole 19a, the male terminal 19 may be coupled to the strip 18. Each male terminal 19 may have a leaf spring structure 12, and the leaf spring structure 12 may be provided at an end portion of the male terminal 19. The leaf spring structure 12 may include an upper spring 12a and a lower spring 12b facing the upper spring 12a. The upper spring 12a may be curved with its central portion protruding upwardly. The lower spring 12b may be curved with its central portion protruding downwardly. Referring to FIGS. 11 and 15, the male terminal 19 may be received in the terminal cavity 15 of the female terminal 11, and the upper spring 12a and the lower spring 12b of the leaf spring structure 12 may be deformed within the terminal cavity 15 of the female terminal 11. As the upper spring 12a and the lower spring 12b of the leaf spring structure 12 elastically press an inner surface of the female terminal 11, the connection between the male terminal 19 and the female terminal 11 may be enhanced. Thus, an electrical contact between the male terminal 19 and the female terminal 11 may be reliably established. As the leaf spring structure 12 is provided at the end portion of the male terminal 19, visual inspection and automatic dimensional measurement of the leaf spring structure 12 may be easily performed so that the quality of the leaf spring structure 12 may be reliably secured.

The housing 20 may have a mounting space 29 receiving a terminal position assurance (TPA) mechanism 50. The mounting space 29 may be recessed in the second portion 22 of the housing 20, and the mounting space 29 may be located between the first portion 21 and the second portion 22. The mounting space 29 may communicate with the cavity 23 and the terminal passing holes 27, and the TPA mechanism 50 may be movable within the mounting space 29 of the housing 20 in a height direction of the housing 20.

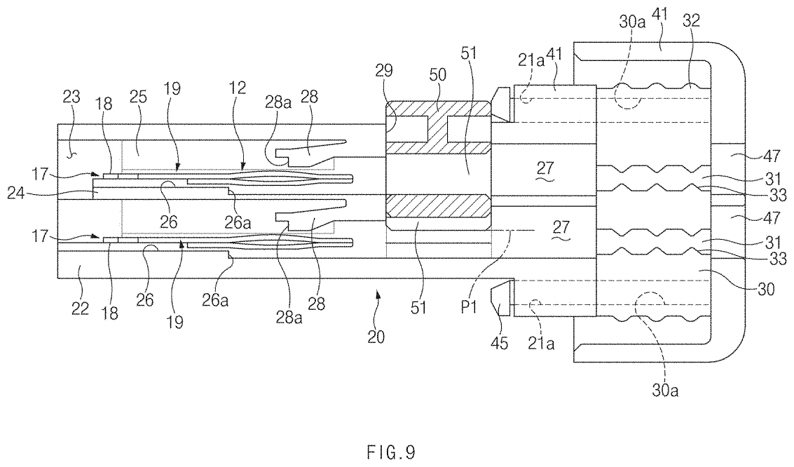

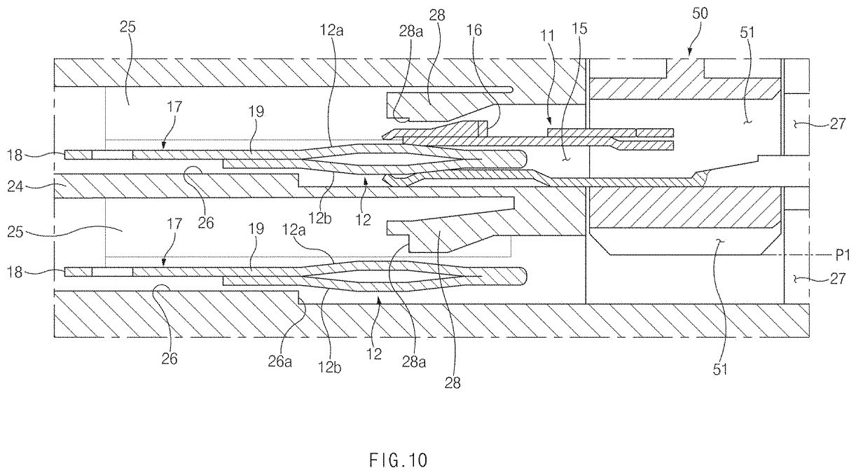

The TPA mechanism 50 may have a plurality of terminal channels 51, through which the plurality of female terminals 11 individually pass. The plurality of female terminals 11 may individually pass through the plurality of terminal channels 51 so that the TPA mechanism 50 may secure the positions of the plurality of female terminals 11. The TPA mechanism 50 may be movable between a first position P1 (see FIGS. 9 and 10), in which the female terminal 11 is allowed to move in a longitudinal direction of the housing 20, and a second position P2 (see FIG. 11), in which the female terminal 11 is not allowed to move in the longitudinal direction of the housing 20.

Referring to FIGS. 9 and 10, when the TPA mechanism 50 is in the first position P1, the terminal channels 51 of the TPA mechanism 50 may be completely aligned with the terminal passing holes 27 of the first portion 21. Thus, the female terminals 11 may be allowed to move through the terminal passing holes 27 of the first portion 21 and the terminal channels 51 of the TPA mechanism 50.

Referring to FIG. 11, when the TPA mechanism 50 is in the second position P2, the terminal channels 51 of the TPA mechanism 50 may not be completely aligned with the terminal passing holes 27 of the first portion 21. Thus, rear ends of the female terminals 11 may be stopped by the TPA mechanism 50 and the female terminals 11 may not be allowed to move.

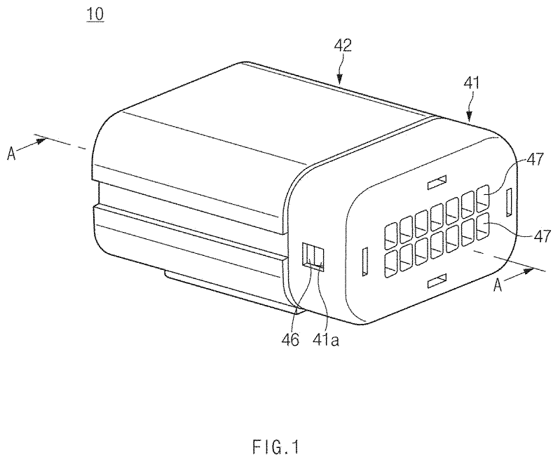

Referring to FIGS. 1, 2, 3, 16, and 17, the joint connector 10 according to an embodiment of the present disclosure may include a first cover 41 and a second cover 42, by which the housing 20 is entirely covered. The first cover 41 may be adjacent to the first portion 21 of the housing 20, and the second cover 42 may face the first cover 41.

The first cover 41 may have a plurality of insertion holes 47 aligned with the terminal passing holes 27 of the first portion 21 of the housing 20. The female terminal 11 may be inserted into the insertion hole 47 and be received in the recess 26 of the cavity 23. The first cover 41 may include a plurality of latch arms 43. Each latch arm 43 may extend from the first cover 41 toward the housing 20, and the latch arm 43 may have a first latch hook 45. The first portion 21 of the housing 20 may have a plurality of first slots 21a, and the seal block 30 may have a plurality of second slot 30a. The plurality of first slots 21a may be aligned with the plurality of second slots 30a respectively. The latch arms 43 may be inserted into the first slots 21a and the second slots 30a respectively. The first latch hook 45 of each latch arm 43 may be snap-fitted to a back surface 21b of the first portion 21 so that the first cover 41 may be coupled to the housing 20.

The second cover 42 may receive the housing 20 and the seal block 30. The second cover 42 may have a ledge 44 extending toward the first cover 41, and the ledge 44 may have a plurality of second latch hooks 46 protruding from an outer surface of the ledge 44 toward the first cover 41. The first cover 41 may have a plurality of third slots 41a. The second latch hooks 46 may be snap-fitted into the third slots 41a of the first cover 41 so that the second cover 42 may be coupled to the first cover 41.

Referring to FIG. 2, the second cover 42 may have a plurality of support projections 48 holding the bus bar 17. As each support projection 48 holds the bus bar 17, the bus bar 17 may be stably supported in the cavity 23 of the housing 20.

The joint connector 10 according to an embodiment of the present disclosure may include the seal block 30 tightly contacting or tightly attached to the housing 20. The seal block 30 may be interposed between the first cover 41 and the first portion 21 of the housing 20. For example, the seal block 30 may have a vertical cross section corresponding to that of the first portion 21 of the housing 20.

The seal block 30 may be made of a material having elasticity and sealability, such as rubber. Referring to FIG. 2, the seal block 30 may have the plurality of receiving holes 31, each of which receives the electrical wire 5 connected to the female terminal 11. The receiving holes 31 may be aligned with the terminal passing holes 27 of the first portion 21 respectively, so that the female terminals 11 may pass through the receiving holes 31 and be located within the recesses 26.

Referring to FIGS. 2 and 3, the seal block 30 may include a plurality of outer seal lips 33 protruding from an outer surface of the seal block 30 toward the first cover 41, and a plurality of inner seal lips 32 protruding from an inner surface of each receiving hole 31 toward the center of the receiving hole 31. Each outer seal lip 33 may be continuously formed along an outer peripheral edge of the seal block 30. When the outer seal lip 33 contacts the ledge 44 of the second cover 42, it may be deformed to seal an inner surface of the ledge 44. Each inner seal lip 32 may be continuously formed along an inner peripheral edge of the receiving hole 31. When the inner seal lip 32 contacts an outer surface of the electrical wire 5, it may be deformed to seal the outer surface of the electrical wire 5.

The seal block 30 may be located within the ledge 44 of the second cover 42, and the ledge 44 of the second cover 42 may be interposed between a flange of the first cover 41 and the outer seal lips 33 of the seal block 30. When the female terminal 11 is electrically connected to the male terminal 19 within the cavity 23 of the housing 20, the inner seal lips 32 of the seal block 30 may tightly contact the outer surface of the electrical wire 5 connected to the female terminal 11, and the inner seal lips 32 may be deformed with respect to the outer surface of each electrical wire 5. Thus, the plurality of electrical wires 5 may be connected to the housing 20 in a sealing manner by one seal block 30. When the second cover 42 is coupled to the first cover 41, the plurality of outer seal lips 33 may tightly contact the ledge 44 of the second cover 42, and the outer seal lips 33 may be deformed with respect to the ledge 44. Thus, the sealability between the first cover 41 and the second cover 42 may be secured.

An assembly process of the joint connector 10 according to an embodiment of the present disclosure is described below.

First, the plurality of bus bars 17 may be mounted in the cavity 23 of the housing 20. Referring to FIG. 4, two bus bars 17 may be press-fitted into the cavity 23 of the housing 20. The upper bus bar 17 may be press-fitted to the top of the horizontal partition 24, and the lower bus bar 17 may be press-fitted to the bottom of the second portion 22 of the housing 20. As illustrated in FIGS. 9 and 10, the male terminals 19 of each bus bar 17 may be located in the recesses 26 of the housing 20.

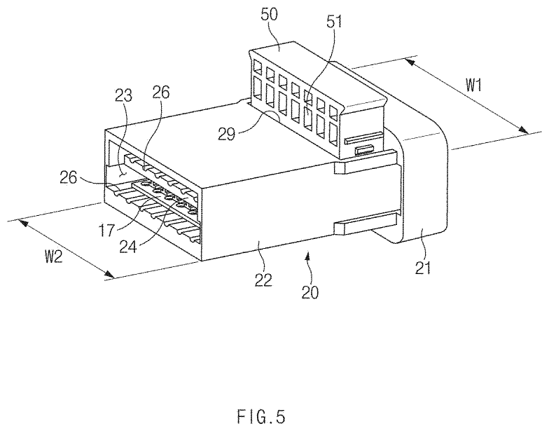

Then, as illustrated in FIG. 5, the TPA mechanism 50 may be received in the mounting space 29 of the housing 20. Here, as illustrated in FIGS. 9 and 10, the TPA mechanism 50 may be in the first position P1, in which the female terminals 11 are allowed to move in the longitudinal direction of the housing 20.

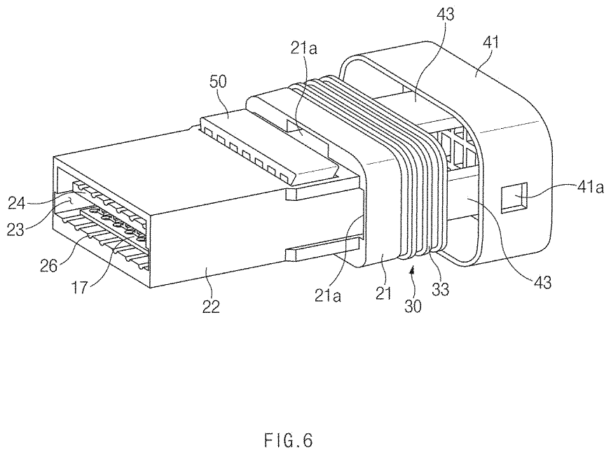

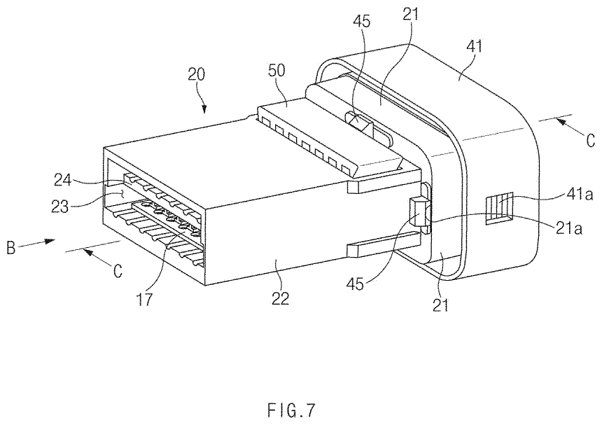

When the TPA mechanism 50 is in the first position P1, as illustrated in FIG. 6, the latch arms 43 of the first cover 41 may be inserted into the first slots 21a of the first portion 21 of the housing 20 and the second slots 30a of the seal block 30. As illustrated in FIGS. 7-9, the first latch hooks 45 of the latch arms 43 may be coupled to the back surface 21b of the first portion 21 of the housing 20, and the first cover 41 and the seal block 30 may be coupled to the first portion 21 of the housing 20.

Thereafter, as illustrated in FIG. 10, the female terminals 11 may move toward the male terminals 19 located in the recesses 26 of the housing 20. As illustrated in FIG. 11, when the female terminals 11 move to a position in which they are connected to the male terminals 19, the engaging ends 28a of the locking lances 28 may engage with the engaging shoulders 16 of the female terminals 11. When the engaging ends 28a of the locking lances 28 engage with the engaging shoulders 16 of the female terminals 11, the leaf spring structures 12 of the male terminals 19 may be elastically coupled to the terminal cavities 15 of the female terminals 11. The TPA mechanism 50 may move to the second position P2 so that the positions of the female terminals 11 may be secured.

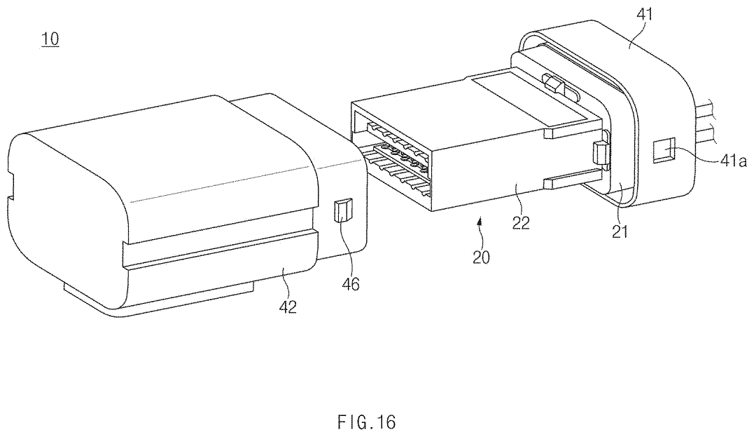

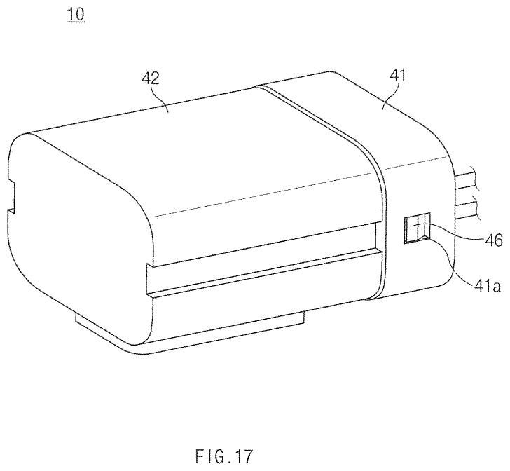

Then, the second cover 42 may move toward the first cover 41 as illustrated in FIG. 16, and the second latch hooks 46 of the second cover 42 may be snap-fitted into the third slots 41a of the first cover 41 as illustrated in FIG. 17.

As set forth above, according to embodiments of the present disclosure, the sealability between the wires 5 connected to the female terminals 11 and the housing 20 may be improved by the seal block 30 having the plurality of receiving holes 31. In particular, compared to the related art, the joint connector 10 according to the embodiments of the present disclosure may achieve the sealability between the wires 5 connected to the female terminals 11 and the housing 20 using one seal block 30 so that the watertightness of the joint connector may be significantly improved. In particular, a gap between the electrical wires may be significantly reduced so that the size of the joint connector may be reduced, and the electrical wires may become thinner.

According to the embodiments of the present disclosure, the leaf spring structure 12 may be provided at the male terminal 19. Thus, there is no concern about the deformation of the leaf spring structure 12 and the female terminal 11, and the electrical contact between the male terminal 19 and the female terminal 11 may be reliably maintained.

According to the embodiments of the present disclosure, the male terminal 19 may have the leaf spring structure 12, and the leaf spring structure 12 of the male terminal 19 may be elastically deformed within the terminal cavity 15 of the female terminal 11. Thus, the connection between the male terminal 19 and the female terminal 11 may be enhanced, and the electrical contact between the female terminal 11 and the male terminal 19 may be reliably maintained within the housing 20. In particular, as the leaf spring structure 12 is provided at the end portion of the male terminal 19, the visual inspection and automatic dimensional measurement of the leaf spring structure may be easily performed. Thus, the quality of the leaf spring structure may be reliably secured.

Hereinabove, although the present disclosure has been described with reference to the specific embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. A joint connector, comprising:
a bus bar having a plurality of male terminals;
a plurality of female terminals electrically connected to the plurality of male terminals;
a housing having a cavity receiving the bus bar and the plurality of female terminals; and
a seal block having a plurality of receiving holes and contacting the housing,
wherein each receiving hole receives an electrical wire connected to each female terminal.

2. The joint connector according to claim 1, wherein the housing has a first portion and a second portion,
wherein the cavity is defined within the second portion of the housing,
wherein the first portion of the housing has a plurality of terminal passing holes communicating with the cavity, and
wherein each female terminal passes through each terminal passing hole.

3. The joint connector according to claim 2, wherein the plurality of receiving holes is aligned with the plurality of terminal passing holes.

4. The joint connector according to claim 2, further comprising a first cover and a second cover facing the first cover to cover the housing,
wherein the first cover is adjacent to the first portion of the housing, and
wherein the seal block is interposed between the first cover and the first portion of the housing.

5. The joint connector according to claim 4, wherein the seal block includes a plurality of outer seal lips protruding from an outer surface of the seal block toward the first cover, and a plurality of inner seal lips protruding from an inner surface of the receiving hole toward a center of the receiving hole.

6. The joint connector according to claim 5, wherein the second cover has a ledge extending toward the first cover,
wherein the seal block is located within the ledge,
wherein the plurality of outer seal lips contacts the ledge, and
wherein the plurality of inner seal lips contacts the electrical wires connected to the plurality of female terminals.

7. The joint connector according to claim 4, wherein the first cover has a plurality of insertion holes aligned with the plurality of terminal passing holes, and
wherein each female terminal is received in the cavity through each insertion hole.

8. The joint connector according to claim 1, wherein the bus bar has a strip extending in a width direction of the housing, and
wherein the plurality of male terminals extends from the strip.

9. The joint connector according to claim 8, wherein each male terminal has a leaf spring structure, and
wherein the leaf spring structure is provided at an end portion of the male terminal.

10. The joint connector according to claim 9, wherein the leaf spring structure includes an upper spring and a lower spring facing the upper spring.

11. The joint connector according to claim 10, wherein the female terminal has a terminal cavity receiving the leaf spring structure of the male terminal.

12. The joint connector according to claim 1, wherein the female terminal is a clean body terminal.
